(19) United States
(12) Patent Application Publication
(10) Pub. No.: US 2010/0211280 A1
(43) Pub. Date: Aug. 19, 2010

(54) REGENERATIVE BRAKING CONTROL METHOD FOR HYBRID VEHICLES AND/OR FOUR-WHEEL-DRIVE VEHICLES AND ARRANGEMENT FOR VEHICLE USING SAID METHOD

(75) Inventors: Olivier Cayol, Versailles (FR); Gerald Leminoux, Longnes (FR)

Correspondence Address: OBLON, SPIVAK, MCCLELLAND MAIER & NEUSTADT, L.L.P., 1940 DUKE STREET, ALEXANDRIA, VA, 22314, US

(73) Assignee: RENAULT S.A.S., BOULOGNE BILLANCOURT (FR)

(21) Appl. No.: 12/665,579

(22) PCT Filed: Jun. 3, 2008
(86) PCT No.: PCT/FR08/50977

§ 371 Date: Apr. 2, 2010

(30) Foreign Application Priority Data
Jun. 21, 2007 (FR) 0755912

(51) Int. Cl. G06F 19/00

(52) U.S. Cl. 701/70

(57) ABSTRACT

A regenerative braking control method for a hybrid vehicle and an arrangement for a vehicle using the method, whereby the vehicle is provided with an electric machine coupled to the rear wheels of the vehicle by a coupling mechanism and which includes a controller for powering and/or electrically charging an associated battery, the controller being controlled during a regenerative braking mode by a distribution controller implementing the method.

The present invention relates to a method for controlling regenerative braking in a hybrid vehicle or four-wheel-drive vehicle and to an arrangement for a vehicle implementing the method.

In the prior art, there are vehicles which are driven by a combustion engine and by an electric motor. Such a drive system is known as a hybrid drive.

In the prior art there are vehicles in which the drive produced by at least one drive actuator is applied to all four wheels of the vehicle. This is particularly the case, even if not necessary, of hybrid vehicles. In particular, it is known practice to apply the motive or driving force of the combustion engine to a first wheelset and the motive force of an electric motor to a second wheelset of the vehicle.

Finally, in the prior art, it is known practice, when there is an electric machine operating as a motor to drive the vehicle, to operate it under braking, that is to say, from an electrical standpoint, that this machine, which then operates as a generator, converts the mechanical energy applied to its rotor into an electrical current which can then be regulated in an electric machine controller by way of current for charging an electric battery. In this mode of operation, the consumption of mechanical energy produced by the electrical conversion applies a braking torque to the wheels of the vehicle. What this means firstly is that the vehicle can be at least partially braked using the electric drive machine operating as a generator and secondly that the kinetic energy recuperated under braking can be converted into electrical energy, thus improving the overall energy efficiency of the vehicle as it drives along.

However, the prior art also discloses solutions to the problem of stability of the vehicle under drive or under braking which demands apportioning of the driving or braking forces between the front wheelset and the rear wheelset. In particular, it is known that braking forces on the front wheelset have to be higher than the braking forces on the rear wheelset.

Now, when the electric machine is on the rear wheelset and the combustion engine is on the front wheelset, the recuperation of energy under regenerative braking needs to be lower than can be achieved.

The present invention addresses these disadvantages of the prior art. Specifically, the invention relates to a method of controlling regenerative braking in a hybrid vehicle, or a 4-wheel-drive vehicle, or a 2-wheel-drive vehicle, in which the rear wheelset is coupled to a regenerative electric machine. The method consists in determining the grip potential on each of the wheels, in testing an equal-grip condition on the measured potentials, and in deducing a command signal for the regenerative braking in such a way as to optimize regeneration.

According to one aspect of the invention, the grip potential is calculated as a function of the vertical forces and of the longitudinal forces on each wheelset and/or wheel of a wheelset.

According to one aspect of the invention, the equal-grip condition is established on the basis of a second-order relationship establishing the apportioning of force between front and rear.

The invention also relates to an arrangement for a vehicle implementing the method, the vehicle comprising a combustion engine for driving the front wheels. The arrangement consists in the fact that the vehicle is provided with an electric machine coupled by a coupling means to the rear wheels of the vehicle and of which the controller for powering and/or electrically charging an associated battery is commanded in a regenerative braking operating mode by an apportioning controller executing the method of the invention.

According to one aspect of the invention, the coupling means comprises a differential coupled to the rear wheels.

According to one aspect of the invention, the coupling means comprises a clutch connected to the differential.

According to one aspect of the invention, the coupling means comprises a reducer coupled to a shaft common to the front wheels and to the rear wheels.

According to one aspect of the invention, the coupling means also comprises a bevel gearbox for transmitting to the front wheels the mechanical force exchanged with the electric machine that is coupled to the rear wheels.

According to one aspect of the invention, the arrangement also comprises a regenerative braking apportioning controller which is connected to a means of commanding the regenerative braking mode, to a means of detecting the longitudinal acceleration, the longitudinal speed and the mass so as to determine a command signal for apportioning the regenerative braking force between the rear wheels and/or the front wheels.

According to one aspect of the invention, the brake apportioning controller also comprises a means for executing an electric running facility and which is connected to a means of commanding electric running and which produces an electric running command signal on the electric machine controller in motor mode and/or on the means of coupling the electric machine to the rear wheels or to the rear wheels and the front wheels.

According to one aspect of the invention, the brake apportioning controller also comprises a means for executing a facility to cover the torque hole which produces a signal to command the electric machine controller in a motor mode and/or on the means of coupling the electric machine to the rear wheels or to the rear wheels and the front wheels so as to fill an engine torque hole produced by a change in state of the drive train leading from the combustion engine.

Other features and advantages of the present invention will be better understood with the aid of the description and attached figures among which:

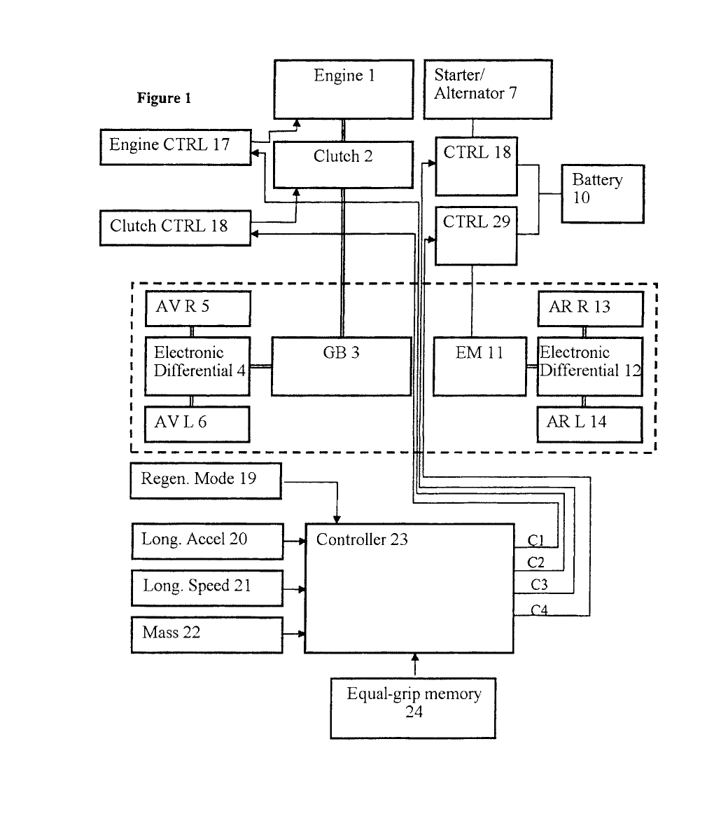

FIG. 1 is a diagram of an arrangement according to one particular embodiment of the invention;

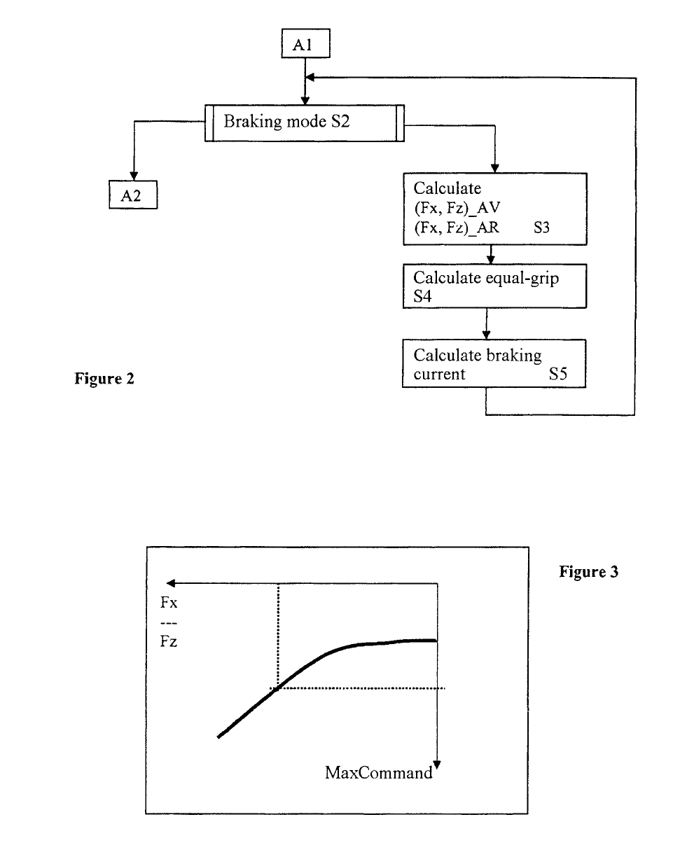

FIG. 2 depicts a preferred embodiment of the method of assembly using an assembly arrangement according to the invention;

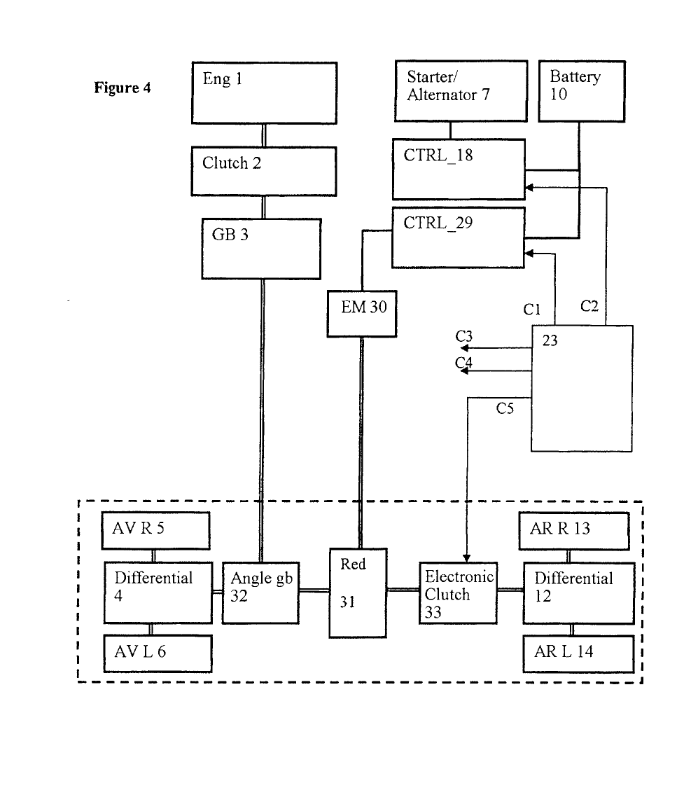

FIG. 3 is a curve explaining one step of the method of FIG. 2; and

FIG. 4 is a diagram of another arrangement according to the invention.

FIG. 1 depicts an arrangement according to the invention. In this architecture, the chassis comprises a front wheelset with a pair of front wheels 5 and 6 coupled by a differential 4 to the secondary shaft of a gearbox 3 the primary shaft of which is driven by a combustion engine 1 via a clutch 2. The combustion engine 1 is also coupled to an alternator-starter 7 the rating of which does not allow it to perform effective regenerative braking on its own.

The rear wheelset comprises two rear wheels 13 and 14 coupled by a differential 12 to the shaft of the rotor of an electric machine 11. The electric machine 11 may be the electric drive machine of a four-wheel-drive hybrid vehicle provided that it is also capable of operating as a generator in a regenerative braking operating mode.

The arrangement of the invention also comprises a brake apportioning controller 23 which receives as input a plurality of input signals which will be detailed hereinafter.

The input signal characteristic of regenerative braking mode indicates that the arrangement of the invention has to operate in regenerative mode under braking and said input signal is produced by a module in order to produce a regenerative braking mode signal 19. This module may comprise a means of evaluating the combination of a logic signal relating to the possibility of performing regenerative braking, switched into the active state by a driving command, and of a signal indicative of activation of vehicle braking. The driving command may be issued by a driving computer or by operating a state switch located at the driving position for the benefit of the driver. The braking activation signal may be produced by a sensor that senses that the brake pedal has been depressed at the driving position and/or by a driving computer.

The input signal characteristic of longitudinal acceleration is produced by a longitudinal acceleration sensor 20 able in particular to determine the longitudinal forces on the front wheels and on the rear wheels, separately.

The input signal characteristic of the longitudinal speed is produced by a longitudinal speed sensor 21 which in particular is able to distinguish the rotational speeds of the front wheels and those of the rear wheels.

The input signal characteristic of the measurement or estimate of mass is produced by a mass measurement or estimating means 22 able in particular to determine the vertical component of the forces on each of the wheels and, more particularly, on each front and rear wheelset.

The brake apportioning controller 23 then comprises a connection with an equal-grip condition database able to determine the highest apportioning of braking between the front wheelset and the rear wheelset and of determining where it falls with respect to this optimum as a function of various requirements associated in particular with traction control, permissible braking distances, etc. The database is recorded in the equal-grip test data memory 24.

The brake apportioning controller 23 then produces one to four command signals and of necessity produces a command signal C4 for the power controller 9 which regulates the current delivered by the electric machine so as to regulate the resistive torque it applies to the rear wheels 13 and 14. To do this, the power controller 9 comprises a means for regulating the current produced by the electric machine 11 operating as a generator, on the basis of a setpoint for braking force on the rear wheels which is permanently determined by the controller 23 during the operation in regenerative braking mode.

In a particular embodiment, the brake apportioning controller 23 also produces a command signal C3 for the power controller 8 which controls the current of the electric machine 7, in particular, when it is an alternator-starter for the combustion engine 1. The command signal C3 then makes it possible, as a function of the apportioning of braking force between front and rear, to control the current charging the battery 10 which may be produced by the alternator-starter to supplement the current delivered by the electric machine 11 coupled to the rear wheels.

In one particular embodiment, the controller that controls the apportioning of braking in regenerative braking mode 23 produces command signals C1 intended for actuators of the combustion engine 1 and of the clutch 2 when the clutch is an electronic clutch. In practice, in all events, these signals C1 and C2 are associated with friction-braking signals applied to the front wheels and, if necessary to make up the remaining braking force not available from the electric machine 11 in regenerative braking, with signals for friction braking applied to the rear wheels. Because these signals are applied only in conjunction with the means of the invention or are applied when the method of the invention is not being executed, for example when the vehicle is operating outside of the regenerative braking mode, these friction-braking signals are not described in any greater detail, nor are they depicted in the drawing.

FIG. 2 depicts the flow diagram of the method of the invention in its preferred embodiment. When the vehicle A1 is operating, a step S2 detects whether there is a change of mode of operation to regenerative braking. If there is not, vehicle operation outside of regenerative braking is resumed. If it is, the control moves on to step S3 during which the brake apportioning controller 23 or a corresponding calculation member associated with the controlled vehicle calculates, on the basis of the acceleration and of the estimated mass, the longitudinal Fx and vertical Fz forces both on the front wheelset and on the rear wheelset. From this, two pairs of values (Fx, Fz)_AV on the front wheelset and (Fx, Fz)_AR on the rear wheelset are deduced and these make it possible to calculate the grip potential on the front wheelset and on the rear wheelset respectively using μ_AV=Fx_AV/Fz_AV and μ_AR=Fx_AR/Fz_AR.

In a later step S4, the brake apportioning controller 23 or a corresponding calculation member associated with the controlled vehicle calculates a command condition for generating at least one command signal C4 (FIG. 1) for commanding the current delivered by the electric machine in regenerative braking on the rear wheels (machine 11 in FIG. 1) in order to converge toward an overall braking command for an equal-grip situation. The other command signals, notably C1 to C3, are deduced from this equal-grip condition taking the demanded total braking force into consideration.

The braking current which determines the braking torque applied by the electric machine in regenerative braking (the machine 11 in FIG. 1) is then determined in a step S5 and the process is resumed from step S2 as long as regenerative braking is still in progress.

FIG. 3 depicts a curve representing a braking condition for equal grip between the front wheels AV and the rear wheels AR as a function of the grip potential Fx/Fz. In a preferred embodiment, the maximum setpoint relationship is determined by a second-order function, the curve depicted therefore being a parabola. The grip potential data plotted on the abscissa axis dictates, on the ordinate axis, the maximum regenerative braking command that can be applied to the regenerative braking electric machine (such as the machine 11 in FIG. 1). This curve is recorded in the equal-grip conditions database recorded in the equal-grip conditions memory 24 (FIG. 1) and, in practice, is so as a function of various parameters such as braking distance, road condition or alternatively the rate of slip of the wheel on the road, and several conditions are recorded and used selectively during step S4 of the aforementioned method.

FIG. 4 depicts another arrangement according to the invention in which the vehicle architecture differs from the architecture of FIG. 1. However, the same elements in FIG. 4 bear the same reference numerals and will not be described further.

In the chassis of the embodiment of FIG. 4, the vehicle originally had just a combustion engine 1 coupled to a drive line so as to effect four-wheel drive. In order to allow this vehicle to benefit from regenerative braking, the arrangement of the invention consists in inserting a reduction gear on the output shaft of a bevel gearbox 32 the other output shaft of which is connected to the front wheels differential 4 while the output from the reduction gear 31 is coupled to an electronic clutch 33. The reduction gear 31 is also coupled to an electric machine 31 the power controller 9 of which supplies it with electrical current from the battery 10 or allows it to deliver charging current under regenerative braking.

It will be noted that the arrangement of the invention allows various facilities to be offered according to the architecture of the vehicle in which the arrangement is fitted.

In particular, when the arrangement is fitted to a four-wheel-drive vehicle with just one combustion engine as depicted in FIG. 4, it allows a regenerative braking facility to be offered on just the front wheels by opening the rear clutch 33 by commanding the actuator of the electronic clutch 33 using an appropriate command signal C5.

In another embodiment, provision is also made to offer a regenerative braking facility on both the front wheels and the rear wheels by producing a proportional command using an appropriate command signal C5 produced by the brake apportioning controller 23 and applied to a known actuator of the electronic clutch 33. It then becomes possible not only to apply an overall regenerative braking setpoint FR_T using a command signal C1 commanding the regenerative current produced by the regenerative braking electric machine 30, but also to apply a proportional command K using a command signal C5 applied to the actuator of the electronic clutch 33 and calculated according to the method of the invention such that:

Fx_{—}AV+Fx_{—}AR<FR_{—}T

Fx_{—}AV=K*FR_{—}T

Fx_{—}AR=(1−K)*FR_{—}T

which from a total regenerative braking setpoint FR_T determines the braking forces Fx_AV applied to the front wheels AV and Fx_AR applied to the rear wheels AR.

According to one aspect of the invention, the electric machine of the arrangement of the invention may be arranged on the rear wheelset if the combustion engine is fitted to the front wheelset, and this will contribute to balancing the load on the two wheelsets of the vehicle.

According to one aspect of the invention, the arrangement may also be fitted in the way described in relation to FIG. 1 or alternatively in relation to FIG. 4, to a four-wheeled vehicle with just one driven wheelset. In this case, and if the originally driven wheelset is the front wheelset, the arrangement of the invention consists in fitting an electric machine to the rear wheelset, either according to the architecture of FIG. 1 in which the electric machine is connected directly to a rear differential or according to the architecture of FIG. 4 in which the electric machine is fitted to the rear wheels through an electronic clutch connected to a rear differential and, if appropriate, but not necessarily, as has also been depicted in FIG. 4, to the front wheels through a reduction gear 31 and a bevel gearbox 32.

In particular, when the arrangement is fitted to a four-wheel-drive vehicle with just a combustion engine as depicted in FIG. 4, it allows the facility of electric operation. To do this, the combustion engine 1 is decoupled from the drive train by ceasing ignition upon a command signal C2, or alternatively by declutching. In this embodiment, the brake apportioning controller 23 also acts as an electric running mode controller. It collaborates with an electric running operating mode command means positioned like the regenerative braking operating command means 19 of the arrangement of FIG. 1. The controller 23 of the arrangement of the invention then produces a command signal C1 for the electric machine 31 which is powered through its power controller 9 in such a way as to deliver a motive torque to the drive line. In addition, the controller 23 of the arrangement then produces a command signal C5 intended for a suitable actuator of the clutch 33 so that, depending on the state of activation produced by the command signal C5, drive may be applied to the front wheels alone if the clutch 33 is decoupled or to the front and rear wheels if the clutch 33 is engaged.

In particular, when the arrangement is positioned on a four-wheel-drive vehicle with just a combustion engine as depicted in FIG. 4, it provides the facility of covering the torque hole. What actually happens in a vehicle equipped with a combustion engine and with a gearbox, is that there are changes in state of the drive train that transmits motive force to the wheels of the vehicle during which the torque is considerably reduced or even zero. This is caused in particular by mechanical clearances but also when a gearbox with discrete gear ratios passes through neutral. For this reason, the regenerative braking controller 23, which has a means for executing a facility to cover the torque hole, comprises a means for detecting a transition in state of the drive train. When the means for executing a facility to fill the torque hole detects such a transition, it produces a command signal to command the electric machine controller in motor mode and/or the means of coupling the electric machine to the rear wheels or to the rear wheels and front wheels in order to fill a hole in the engine torque produced by a change in state of the drive train leading from the combustion engine.

Of note here is a particular advantage that the invention has over numerous solutions to the problem of vehicle stability, namely that of simplifying the calculation of the operating point of the combustion engine through the presence of just one electric machine intervening under braking and if necessary for electric driving or for filling the torque hole, making it possible to achieve an optimum operating point.

Of note also is another advantage of the invention which, in the case of the architecture depicted in FIG. 4 in which a rear electronic clutch is provided, is that of gaining a degree of freedom in the optimum solution of the problem of stability because it becomes possible to calculate separately the braking and/or driving force produced by the electric machine and the torque actually exchanged with the rear wheels or with the rear wheels and front wheels by virtue of control by the command signal C5 of the rear electronic clutch 33.

1-11. (canceled)

12. A method of controlling regenerative braking in a hybrid vehicle, or a 4-wheel-drive vehicle, or a 2-wheel-drive vehicle, in which a rear wheelset is coupled to a regenerative electric machine, the method comprising:
determining a grip potential on each of the wheels;
testing an equal-grip condition on the measured grip potentials; and
deducing a command signal for the regenerative braking to optimize regeneration.

13. The method as claimed in claim 12, wherein the grip potential is calculated as a function of vertical forces and of longitudinal forces on each wheelset and/or wheel of a wheelset.

14. The method as claimed in claim 12, wherein the equal-grip condition is established on the basis of a second-order relationship establishing apportioning of force between front and rear.

15. An arrangement for a vehicle implementing a method, the vehicle comprising:
a combustion engine for driving front wheels of the vehicle;
wherein the vehicle includes an electric machine coupled by a coupling means to rear wheels of the vehicle; and
a controller for powering and/or electrically charging an associated battery, commanded in a regenerative braking operating mode by an apportioning controller executing the method.

16. The arrangement as claimed in claim 15, wherein the coupling means comprises a differential coupled to the rear wheels.

17. The arrangement as claimed in claim 15, wherein the coupling means comprises a clutch connected to the rear differential.

18. The arrangement as claimed in claim 15, wherein the coupling means comprises a reduction gear coupled to a shaft common to the front wheels and to the rear wheels.

19. The arrangement as claimed in claim 15, wherein the coupling means comprises a bevel gearbox transmitting to the front wheels mechanical force exchanged with the electric machine that is coupled to the rear wheels.

20. The arrangement as claimed in claim 15, wherein the regenerative braking apportioning controller is connected to a means for commanding a regenerative braking mode, to a means for detecting longitudinal acceleration, longitudinal speed, and mass so as to determine a command signal for apportioning the regenerative braking force between the rear wheels and/or the front wheels.

21. The arrangement as claimed in claim 15, wherein the brake apportioning controller further comprises means for executing an electric running facility and which is connected to means for commanding electric running and which produces an electric running command signal on the electric machine controller in a motor mode and/or on the means for coupling the electric machine to the rear wheels or to the rear wheels and the front wheels.

22. The arrangement as claimed in claim 15, wherein the brake apportioning controller further comprises means for executing a facility to cover a torque hole that produces a signal to command the electric machine controller in a motor mode and/or on the means for coupling the electric machine to the rear wheels or to the rear wheels and the front wheels so as to fill an engine torque hole produced by a change in state of the drive train leading from the combustion engine.
